(19) United States
(12) Patent Application Publication
(10) Pub. No.: US 2003/0174179 A1
(43) Pub. Date: Sep. 18, 2003

(54) Tool for visualizing data patterns of a hierarchical classification structure

(76) Inventors: Henri Jacques Suermondt, Sunnyvale, CA (US); George Henry Forman, Port Orchard, CA (US)

Correspondence Address: HEWLETT-PACKARD COMPANY, Intellectual Property Administration, P.O. Box 272400, Fort Collins, CO, 80527-2400, US

(21) Appl. No.: 10/096,452

(22) Filed: Mar. 12, 2002

(51) Int. Cl. G09G 5/00

(52) U.S. Cl. 345/853

(57) ABSTRACT

A visualization method and tool for gaining insight into the structure of a hierarchy. A derived intuitive display of the relation and effect on classification of features in nodes in a classification hierarchy provides a snapshot of a metric, such as coherence of the hierarchy. The visualization tool displays, in a single view, all or part of the following information: which features are the most powerful in identifying a particular topic; how these features are distributed over items in its sub-classes; which of these features do strongly distinguish among, and help classify items into, subclasses, and which do not (the ones that are shared evenly among the sub-classes justify the grouping as being coherent); and topic relationships among subclasses.

### (2) CROSS-REFERENCE TO RELATED APPLICATIONS

Not Applicable.

### (3) STATEMENT REGARDING FEDERALLY SPONSORED RESEARCH OR DEVELOPMENT

Not Applicable.

### (4) REFERENCE TO AN APPENDIX

Not Applicable.

### (5) BACKGROUND

(5.1) Field of Technology

The present invention relates generally to topical decision algorithms and structures.

(5.2) Description of Related Art

In the past, many different systems of organization have been developed for categorizing different types of items. Such systems can be used for organizing almost anything, from material items (e.g., different types of screws to be organized into storage bins, books to be stored in an intuitive arrangement in a library, viz. the Dewey Decimal System, and the like) to the more recent need, inspired by the computer and Internet revolution, for organized categorization of knowledge items (e.g., informational documents, book content, visual images, and the like). Many known forms of hierarchical organization have been developed, e.g., such as known manner manual assignment, rule-based assignment, multi-category flat categorization (such as Naive Bayes or C4.5 method algorithms), level-by-level hill-climbing categorization (also known as “Pachinko machine” categorization), and level-by-level probabilistic categorization. The creation and maintenance of such hierarchy structures have themselves become a unique problem, particularly for machine-learning researchers who want to understand how to make learning algorithms perform with very high efficiency of automated classification and for those who want to study, maintain and improve very large hierarchy structures.

Using the Internet as an example, a Netscape™ browser search for web site information regarding “Chicago Jazz” yields over a thousand search “hits.” Thus, such a direct topic search provides only a relatively unorganized listing which is often not practically useful without a tedious item-by-item perusal or a substantial search refinement. The more limited the search however, the more likely that appropriate target information may be missed due to improper search term development. Internet Service Providers (“ISP”) often provide web site home page topical categories as links, such as “Arts & Humanities,” “Business & Economy,” etc., wherein the browser can point-and-click their way level-by-level through a hierarchy of supposedly organized knowledge items as developed by the ISP, hoping eventually to reach the knowledge item of interest.

Classification hierarchies are usually authored manually; that is, someone decides on a “good” division into topics (also referred to as the “category,” or “class,” e.g., a computer file), and the hierarchy of subtopics (also referred to as “subcategory” or “subclass”) thereunder. Clearly this is a somewhat subjective process for determining the need for organization of certain topics-of-interest and the specific nodes of the related hierarchy structure. Specific cases (viz., individual items at a node, e.g., such as documents in the file) can then be assigned manually or assigned by automated classification methods to such a class hierarchy. Note importantly, that the quality of such hierarchies is usually judged thereafter subjectively, namely by descriptiveness of the concepts, without looking at the data; that is, without looking to see whether each topically-related case feature distribution (i.e., attributes of the case, e.g., words in the documents) agrees with the chosen grouping. The individual classes and structural appropriateness of such hierarchies is also judged subjectively, generally without any comprehensive or quantitative analysis of individual cases in the classes. Thus, there is a need for methods and tools which allow not only such comprehensive hierarchy structural analysis, but also provides a clear communication of the result to the analyst.

Clustering methods and similar machine learning techniques have been applied to generate groupings of items, or cases, and even entire hierarchies, automatically. Such methods usually apply some type of distance, similarity function to group items into like categories. The same distance function can be used to obtain a measure of the quality of the resulting clustering. It would be possible to apply such a distance function to any hierarchy, including manually generated ones, to measure the quality (i.e., tightness) of various categories. The disadvantage of this approach is that empirically it has been established that such automatically generated hierarchies do not correspond to hierarchies that humans find natural or intuitive. Moreover, the accumulated distance of items in a category from a centroid, as measured by most clustering algorithms, does not allow the distinction between shared features and distinctive features. A few distinctive features can make the items in a category look widely dispersed to a clustering metric, even if these items also strongly share some other features. Thus, such methods are inadequate.

One specific METHOD FOR A TOPIC HIERARCHY CLASSIFICATION SYSTEM is described by Suermondt et al. in U.S. patent application Ser. No. 09/846,069, filed Apr. 30, 2001. FIG. 1 is a reproduction from that application which helps to describe one such system. Therein is shown a block diagram of a categorization process 10 of that invention. The categorization process 10 starts with an unclassified item 12 which is to be classified, for example, a raw document. The raw document is provided to a featurizer 14. The featurizer 14 extracts the features of the raw document, for example whether a word one was present and a word two was absent, or the word one occurred five times and the word two did not occur at all. The features from the featurizer 14 are used to create a list of features 16. The list of features 16 is provided to a categorizer system 18 which uses knowledge from a categorizer system knowledge base 20 to select zero, one, or possibly more of the categories, such as an A Category 21 through F Category 26 as the best category for the raw document. The letters A through F represent category labels for the documents. The process 10 computes for the document a degree of “goodness” of the match between the document and various categories, and then applies a decision criterion (such as one based on cost of mis-classification) for determining whether the degree of goodness is high enough to assign the document to the category.

One issue in hierarchy development and management is how coherent each topic is; that is, how much in common each of its sub-topics has (e.g. how well do items like “Soccer” and “Chess” group together under the topic “Entertainment”). This issue may be qualitatively evaluated by humans at a semantic level. However procedurally, coherence can only be addressed for a specific grouping with respect to the features (e.g. words, word roots, phrases) present in the knowledge items under each topic (or “cases” within “classes”). Coherence may be defined as the degree to which the cases in a particular class have important features in common intuitively with cases in closely related classes (e.g., in a tree-form hierarchy, closely related nodes are the parent class and classes that share the same parent, also referred to as descendants), in other words, the “naturalness” of the fit.

Once the least appropriate topics have been found or alternative structural organizational arrangements have been developed and proposed, it would be advantageous to have a technique for visualizing the structure(s) to help to understand the most natural grouping in a structure or among the alternatives. Such an organization of classes should be particularly amenable to creation and maintenance of better hierarchy structural implementations.

Thus some of the specific problems and needs in this field may be described as follows:

It is often difficult for portal builders and editors creating and maintaining a hierarchy type database to get insight as to which classes and which specific cases have a best fit. As a result, some hierarchies or parts thereof are “grab bags” while some are more logically organized. There is a need, among others, for a method and tool that allows the user to intuitively visualize where changes could be beneficial.

It is often difficult to determine whether additional investment in feature selection may be worthwhile to improve classification. There is a need for a method and tool that will show the strength or weakness of features used in hierarchical classification.

It is often useful to identify classes that require more training examples (e.g., because they are less coherent) and others that require fewer (because they are more coherent) in order to train a high-accuracy classifier. There is a need for a method and tool that will indicate where in the hierarchy substantially more training examples will be needed for effective training because of the incoherence and complexity of the learned concept.

These and other problems are addressed in accordance with embodiments of the present invention described herein.

### (6) BRIEF SUMMARY

The embodiments of present invention described herein relate generally to topical decision algorithms and structures. More particularly, hierarchical arrangement systems are considered. An exemplary embodiment is described for a methodology and tool for visualizing data patterns of a classification hierarchy that is useful in classification hierarchy building and maintenance. The process and tool has the ability to help the user identify the fit of classes regardless of the actual current level of appropriateness. The process and tool allows the user to recognize that some of the subclasses of such a class have strong feature correspondence with others, yet while having very little in common with other subclasses of the same class.

The foregoing summary is not intended to be an inclusive list of all the aspects, objects, advantages and features of the present invention nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches. Other objects, features and advantages of the embodiments of the present invention will become apparent upon consideration of the following explanation and the accompanying drawings, in which like reference designations represent like features throughout the drawings.

### (7) BRIEF DESCRIPTION OF THE DRAWINGS

FIG. 1 is a block diagram of a categorization process for developing a hierarchy which may be the subject of the visualization process in accordance with the embodiments of the present invention.

FIG. 2 is a hierarchy diagram in accordance with the embodiments of the present invention.

FIG. 3 is a flow chart of the algorithmic process for producing the visualization tool in accordance with the embodiments of the present invention

FIG. 4A is a first exemplary embodiment of a computer screen showing a derived visualization tool in accordance with the embodiments of the present invention as shown in FIG. 3.

FIGS. 4B-4D is detail of FIG. 4A, including explanatory legends.

FIG. 5 is a second exemplary embodiment computer screen display, comparable to FIGS. 4B-4D.

FIG. 6 is a third exemplary embodiment computer screen display panel, comparable to FIGS. 4B-4D.

The drawings referred to in this specification should be understood as not being drawn to scale except if specifically annotated.

### (8) DETAILED DESCRIPTION

Reference is made now in detail to specific embodiments of the present invention, which illustrate the best mode presently contemplated for practicing the invention. Alternative embodiments are also briefly described as applicable. Subtitles are used herein for convenience only; no limitation on the scope of the invention is intended nor should any be implied therefrom.

Definitions

While the application range of the embodiments of the present invention is broad, for the purposes of describing the embodiments of the present invention, the following terminology is used herein:

A “case” (e.g., an item such as a knowledge item or document) is something that can be classified into a hierarchy of a plurality of possible classes.

A “class” (e.g., topic or category, or in terms of structure, a node) and is a place in a hierarchy where items and other subclasses can be grouped. Thus, as an example of a hierarchy structure representative of a set of computerized informational documents, in computer parlance, a “class” would be a “directory,” a “case” would be a “file” (document “X”), and a “feature” would be a “word.”

A “subclass” is a class that is a child of some node in the hierarchy. There is an is—a hierarchy between a class and subclass (i.e., an item in a subclass is also in the class, but not necessarily the reverse.

A “feature” is one particular property, an attribute (usually measurable or quantifiable), of a case. Features are used by classification methods (during categorization) to determine the class to which a case may belong. As examples, features in text-based hierarchies are typically words, word roots, or phrases. In a hierarchy of diseases, features may be various measurements and test results of sampled patients, symptoms, or other attributes of the specific disease.

A “training set” is a set of known cases that have been assigned to classes in the hierarchy. Depending on the embodiment of the algorithm (and depending on the constraints of the application), cases in the training set may be assigned to exactly one class (and, by inheritance, to the parents (higher nodes of the structure) of that class), or to more than one class. In one embodiment, the cases in the training set may be assigned to classes with a degree of uncertainty, or “fuzziness,” rather than being assigned deterministically.

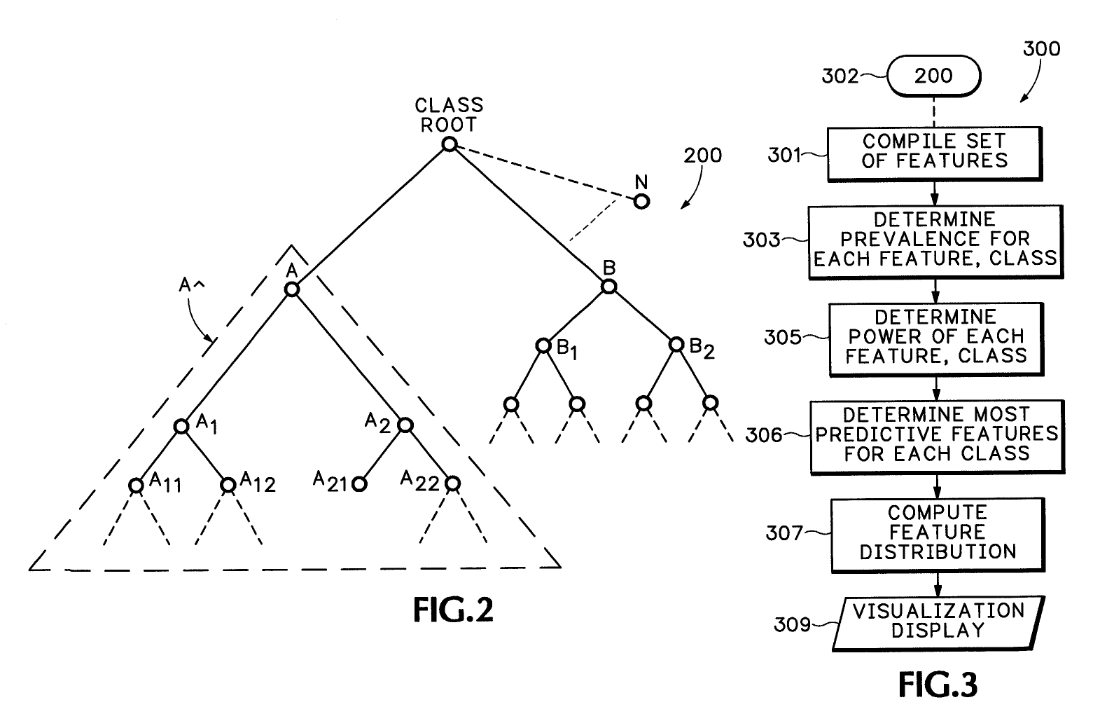

In a hierarchy structure 200, as represented by FIG. 2, the description of embodiments of the present invention describes the logical organization of structural nodes of a hierarchy using the terms:

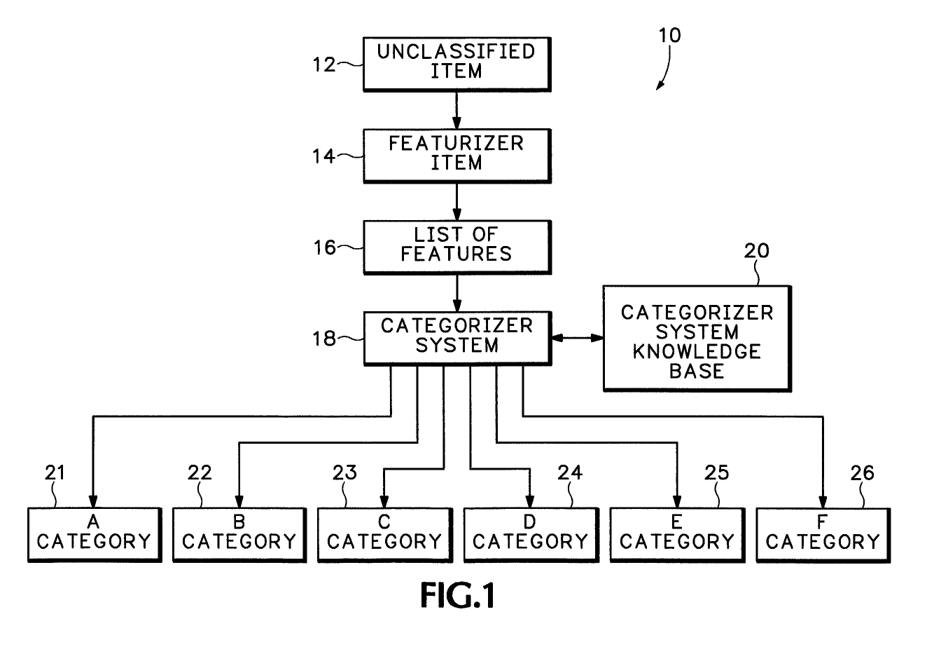

“parent” of a node X as the direct enclosing super-class of the node X, e.g., in FIGS. 1 and 2, A is the parent of A1;

“child” of a node X as a subtopic directly beneath the node X, e.g., A1 and A2 are the children of A (e.g., practically, a topic node “Entertainment” may have two children subtopics “Chess” and “Soccer”);

“sibling(s)” of a node X as the nodes that share the same parent as X, e.g., the siblings of A are the nodes B . . . N;

“descendent(s)” are child nodes, children of child node, et seq.; and

“root” is the apex descriptor, generally a description of the entire organizational structure, e.g., “Yahoo Web Directory.”

Where cases are permitted to be placed at interior nodes and not solely at a terminus node (e.g., traditional hierarchy tree structure “leaf” nodes are terminus nodes; last descendants of a particular family tree hierarchy line are terminus nodes; and the like), a notation such as “A*” refers to a set of cases that are assigned to node “A” itself, not including its children and other descendants. The notation such as “A\hat{ }” refers to a set of cases that are assigned to node “A” or any of its descendants (e.g., in FIG. 2, A\hat{ } includes A* and A1\hat{ } and A2\hat{ }). An is—a relationship is assumed between parent and child nodes; that is, a child A1 is a specialization of its parent topic node A (i.e., the cases in A1* are also members of the topic node A\hat{ }).

It is to be understood that those skilled in the art may use alternative, equivalent terminology throughout (e.g., in a hierarchy “tree” symbology, “trunk” for a fundamental apex topic, “branches” for “parents” and descendants, “twigs” or “sub-branches” for off-spring and siblings, “leaves” for last descendants (terminus nodes), and the like are used); therefore there is no intent to limit the scope of the invention by the use of these defined terms useful for describing embodiments of the invention nor should any be implied therefrom. Specific instances of these general definitions are also provided hereinafter.

General

In the field of understanding and maintaining topical decision algorithms and structures where the form is generally of a hierarchy of classes, embodiments of the present invention introduce a visualization method and tool for gaining insight into the current arrangement and appropriateness of node classes in the hierarchy. The method provides for creating a visualization tool providing feature effect and distribution within a hierarchy. It has been found that automated classification systems (e.g., machine learning of a Pachinko-style hierarchy of neural networks) are likely to perform better if the hierarchy consists of appropriate groupings. The tool allows one to browse a classification hierarchy and easily identify the classes that are “natural” or “coherent,”and the ones that are less so. By identifying incoherent topics and reorganizing the hierarchy to remove such problems, improvements to the hierarchy structure can be provided, in particular, for automated classification methods. As a variety of such methodologies may be employed depending on the specific implementation, a variety of categorization measures may be employed to guide and improve the actual formation of the hierarchy.

More specifically, embodiments of this invention provide an intuitive display of the relationship and effect on classification of features in nodes in a classification hierarchy. The visualization tool displays, in a single view, all or part of the following information:

which features are the most powerful in identifying a particular class;

how these features are distributed over items in sub-classes;

which of these features do strongly distinguish among, and help classify cases into, subclasses, and which do not (i.e., the ones that are shared evenly among the subclasses justify the grouping as being coherent); and

class relationships among subclasses (e.g., the user can quickly see that two of the subclasses are similar and do not fit well with their siblings).

In a practical setting, the hierarchy to be analyzed and visualized comprises given data, namely, (1) a hierarchy of classes, (2) given cases and their assignments to the classes, and (3) given case features, to which the tool is to be applied in order to analyze the hierarchy. These data are used to generate a visualization tool which will show how well the hierarchy is constructed. This informational data can be obtained in a known manner by a process of analyzing relationships among cases in a training set, their case features, and the class assignments in the training set.

Embodiments

FIG. 3 is a flowchart representative of a process 300 of generating visualization. Element 302 is a given set of cases in a hierarchy such as exemplified in FIG. 2.

As represented by flowchart block, or step, 301, a set, or list, is compiled (and possibly ordered) of features for the definition of this set based on the contents of the cases, i.e., individual features into which the case can be decomposed. (Note that in automated data mining and machine learning processes, guidelines for the definition of this compiled set are supplied instead that guide the process to select the features themselves.) A feature can be anything measurable within a specific case. For example if the case is a document, it can be decomposed into its individual words, individual composite word phrases, or the like; in a preferred embodiment where the cases are a plurality of documents, Boolean indicators of whether individual words occur are used; e.g., the choice of which words to look for might be: “all words except those that occur in greater than twenty percent (20%) of all the documents (e.g., “the,” “a,” “an,” and the like) and rare words that occur less than twenty times over all the documents.” In classification problem domains other than text documents, often the training cases come with pre-defined feature vectors (e.g., in a hierarchy of foods, the percent content of daily requirement of various vitamins or number of grams of fat, and the like). New features can be developed for specific implementations.

The distribution of the individual features is derived such that a single display can be generated whereby the user can quickly visualize the current nature, e.g., coherence, of the overall hierarchy structure. As represented by step 303, for each directory X (e.g. in FIG. 2, A, A1, A2, . . . , B, . . . ), determine (1) the number of cases in X\hat{ }, and separately for X*, and (2) the average prevalence of each feature with respect to all cases in X\hat{ } and separately for just those cases in X*. The average prevalence for a Boolean feature is the number of times that feature occurs (i.e., equals “true,” denoted N(f,X\hat{ })) divided by the number of cases determined above, denoted N(X\hat{ }). For a real-valued feature, it is its average value over all cases in the group. Other feature types may be accommodated differently. To continue the example used in the Background section hereinabove, regarding the subtopics “Chess” and “Soccer” with a class “Entertainment,” supra, it might be determined that the word “chess” appears on average in ninety-five percent of the documents in a directory “Chess” (e.g., FIG. 2, Node A1, N(“chess”, A1\hat{ })=950 and N(A1\hat{ })=1000).

As represented by step 305, for each feature, determine its “discriminating power” for each topic X\hat{ }. This characterizes how predictive the presence of the feature is for that topic versus its environment; namely,

X\hat{ } versus all cases assigned to X's parent and X's sibling subtrees (e.g., for node A1, contrast the set of cases in A1\hat{ } versus the set of cases in A2\hat{ } and A* (note: such a measure is not measurable for the root node which has no parents or siblings)), or

between a parent* and its children, X* versus all cases in the children subtrees (e.g., for node A1, contrast the set of cases in A1* versus the set of cases in A11\hat{ } and A12\hat{ }). That is, the goal is to determine which individual features presence would indicate a much higher probability that the document belongs in a particular branch node rather than in a sibling directory or in a parent node. In other words, to develop a visualization tool, it is of concern as to which features are “most powerful” in distinguishing items that are in A\hat{ } from items that are in A's siblings (e.g., B\hat{ } . . . N\hat{ }) or A's parent* (e.g.. A is the parent of A1 and A2, A1 is the parent of A11 and A12, etc.).

As a specific exemplary implementation, let a user be interested in the top “k” features to determine the “discriminating power” for each feature. An embodiment of the invention can be implemented in a computer wherein this measure of discriminating power is obtained using Fisher's Exact Test statistic. All features for a class are then ordered by this statistic. Referring to FIG. 3, this is indicated by element 306. Features, “f,” with a statistic greater than the threshold “X” are determined to be features-of-interest, “fi” (“most powerful”). For example, in the documents-are-cases example, to select a variable length set of the most predictive words in the exemplary document directory “D,” a probability threshold of 0.001 against the Fisher's Exact Test output is used.

The next step, FIG. 3, 307, is to determine, for each node A, with children A1 . . . A_{N}, the degree to which feature “f” of “fi” for A identified in step 306 is distributed uniformly across the children of A. In other words, which of the features of the “powerful set” selected in step 305 are also most uniformly common to the subtrees of the directory.

Continuing the exemplary specific implementation, the subprocess is:

[.1] identify the vector <N(f, A1\hat{ }), N(f, A2\hat{ }), . . . , N(f, An\hat{ })> as well as the vector <N(A1\hat{ }), N(A2\hat{ }), . . . , N(An\hat{ })> (the former vector reflects how each feature “f” is distributed among the subclasses of A, the latter vector reflects how all items are distributed among the subclasses of A); and

[.2] compute the cosine of the angle of these two vectors (the normalized dot-product), wherein values near 1 show good alignment (i.e. uniform feature distribution); e.g., take those greater than 0.9 as sufficiently uniform). Mathematically, in the exemplary embodiment the criterion can be expressed as:

$$\frac{dotproduct ( F , N )}{length ( F ) length ( N )} \geq P , \qquad ( Equation 1 )$$

where F is the vector representing the feature occurrence count for each child subtree, and N is the vector representing the number of documents for each child subtree, and P is the predetermined distribution requirement near 1 (e.g., 0.90), or in other words, the “uniformity” of the feature.

Whether the “most powerful” features identified for class A by e.g., Fischer's Exact Test, supra, are also “most powerful” in distinguishing among the subclasses of A is also determined by comparing with the “most powerful” features that were computed for each child Ai, supra.

As an option, using these measures, a measure of hierarchical coherence can be determined for each class A having children (note, such a measure is senseless for root and terminus nodes; e.g., FIG. 2 node A21). The hierarchical coherence, intuitively, is the degree to which class A has features that are (a) strongly predictive of class A; (b) evenly distributed among children of class A (not predictive of one child in particular); (c) highly prevalent in A and in each of its children.

The tool is embodied in a display of this information in a single view. That is, as represented by element 309, using the metrics described above (e.g., a power metric), an array of the features is sorted by the metric, recorded, and displayed.

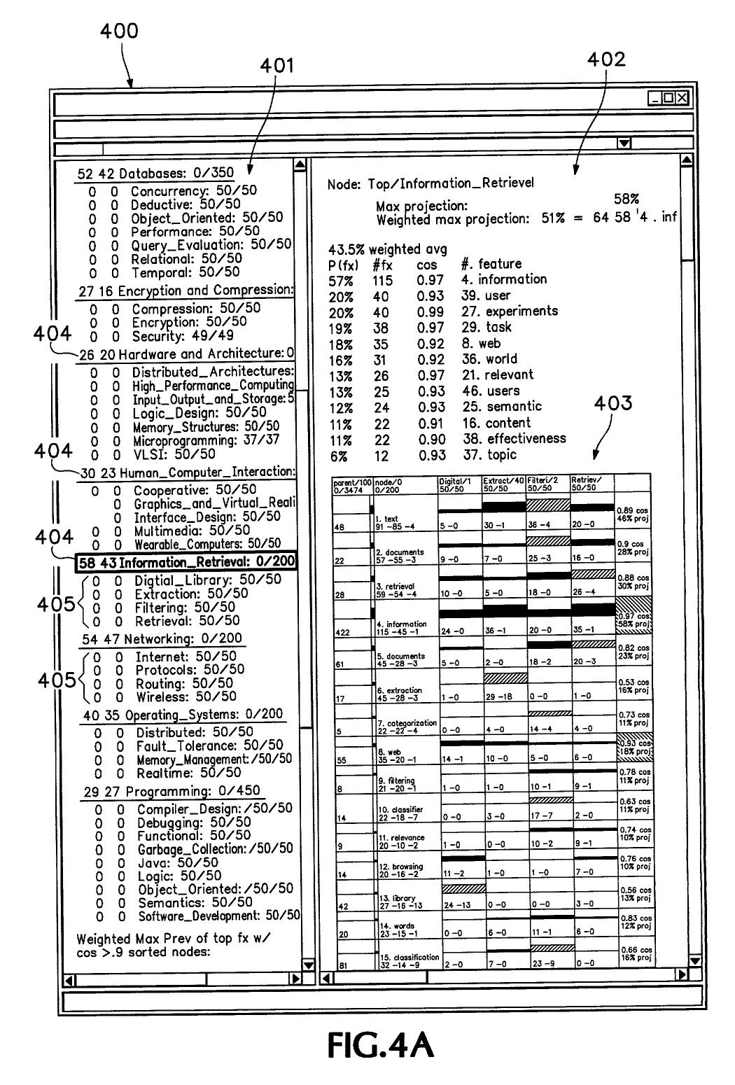

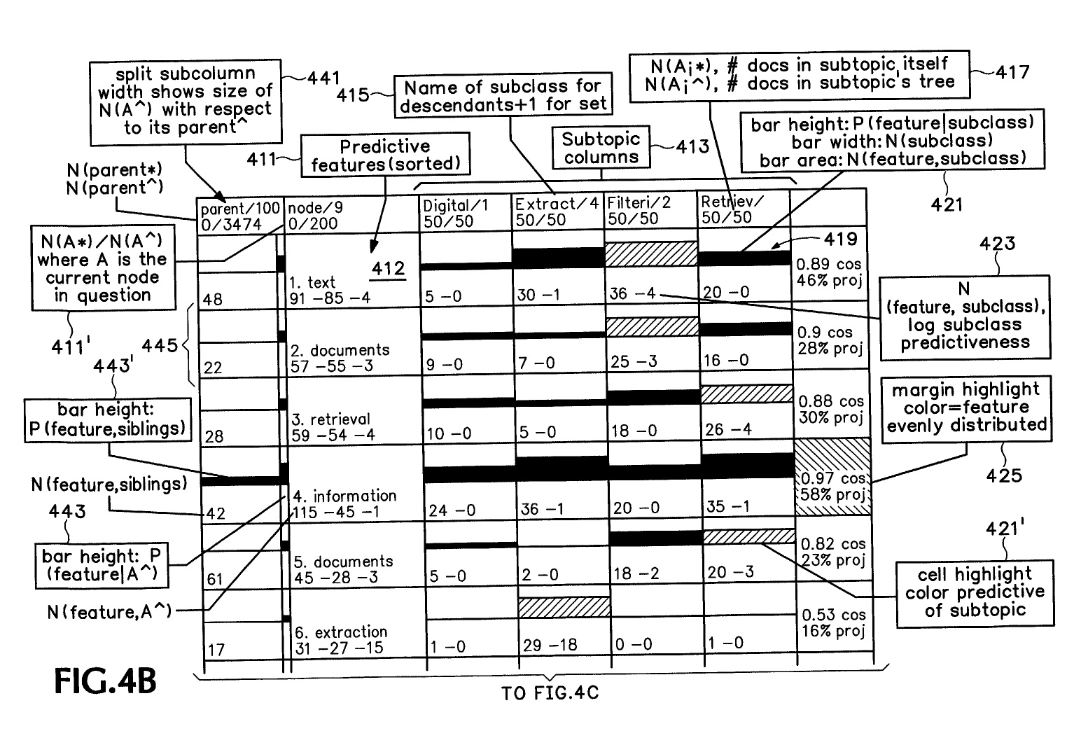

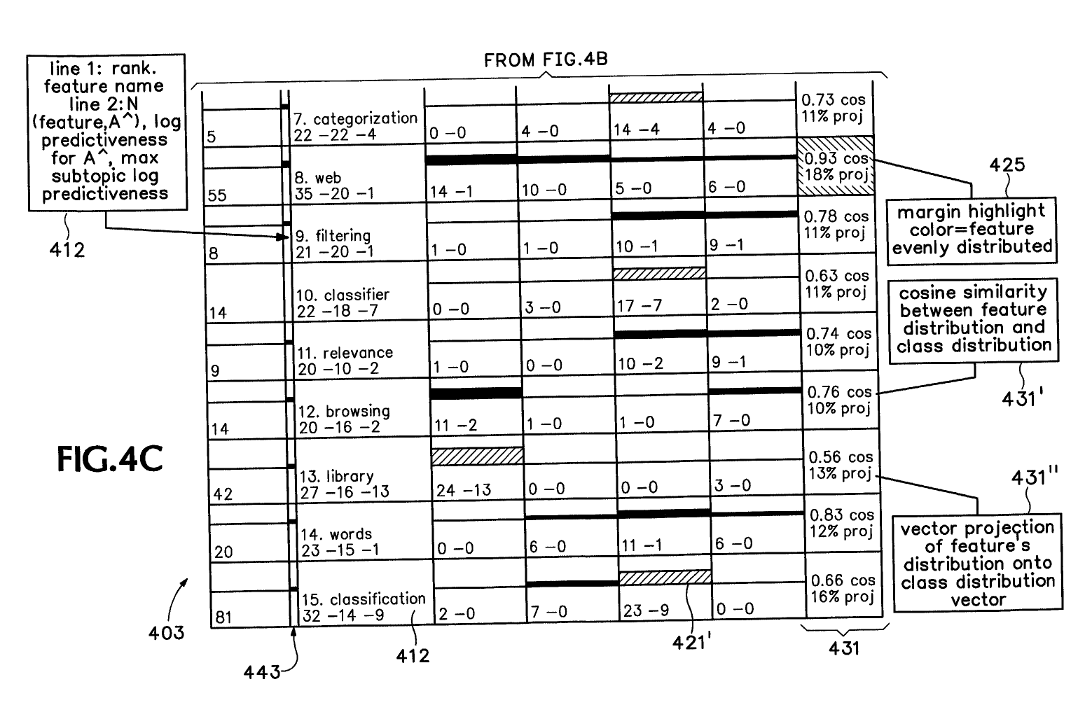

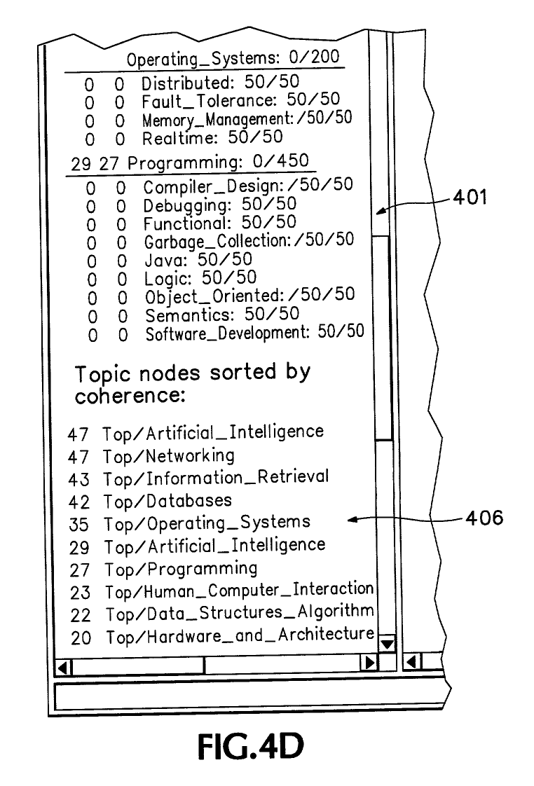

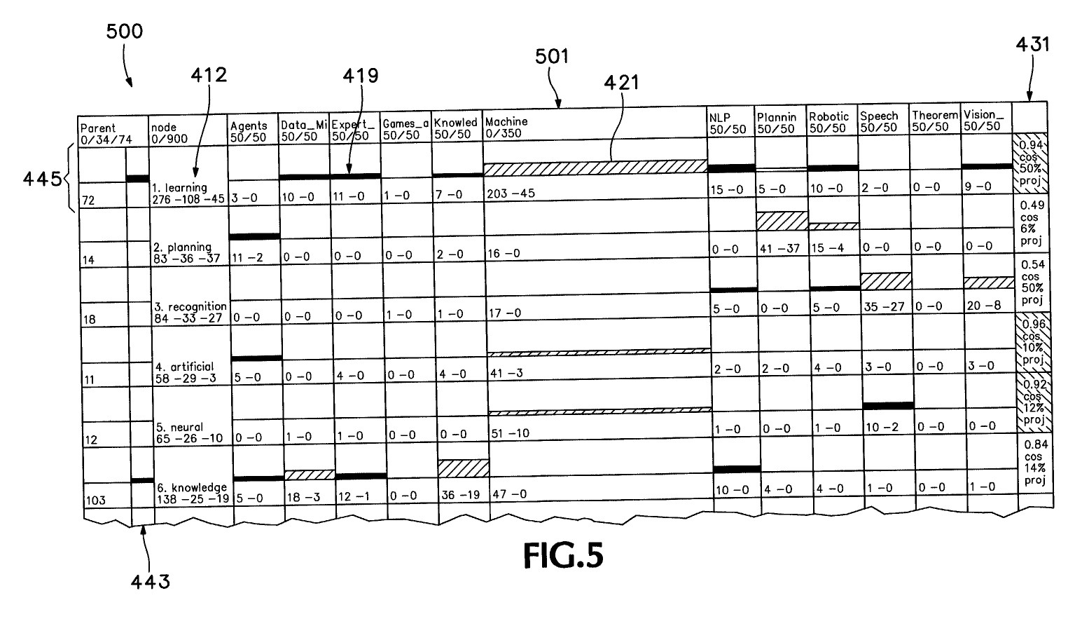

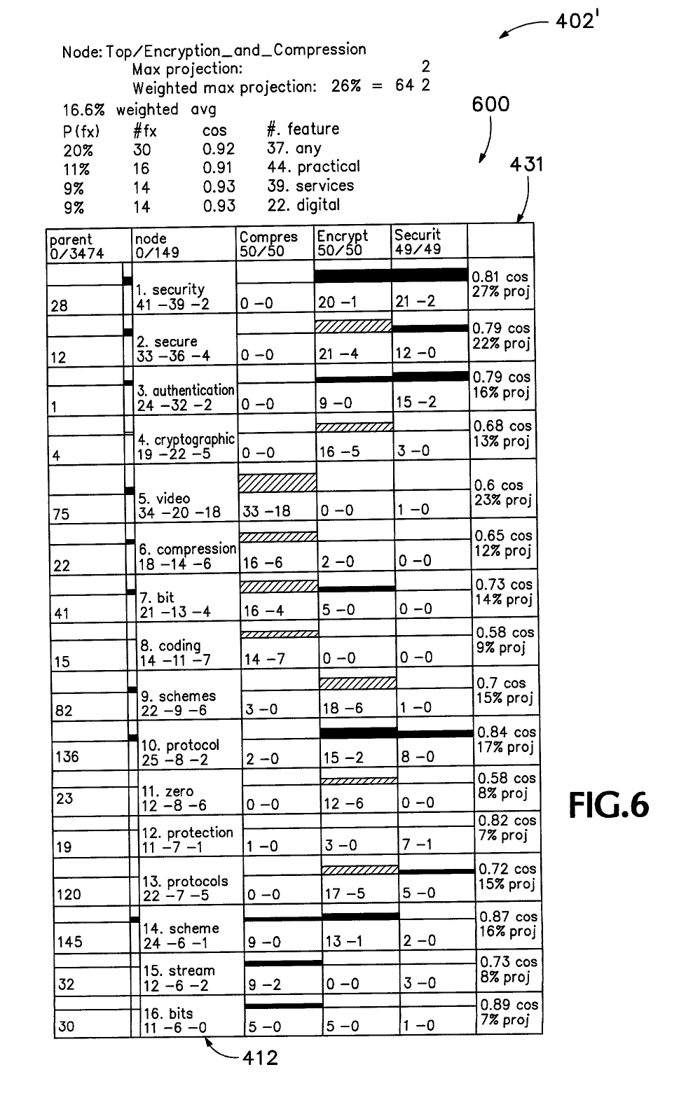

An example of a computer screen display 400 forming a hierarchy visualization tool is shown in FIG. 4A. FIG. 4A shows a computer display “snapshot” of one embodiment of this method that illustrates many of its features. FIGS. 5 and 6 depict alternative snapshots, described as needed hereinafter. These embodiments of the visualization tool are implemented as a program that generates hypertext markup language (“HTML”) output, which can be displayed over the network or locally as a web page. No limitation on the scope of the invention is intended as it will be apparent to those skilled in the art that implementations of the present invention may be readily adapted to other computer languages in a known manner.

The display 400 is split between a first view panel 401 on the left of the computer screen for category navigation, and a second view panel 402 on the right for detailed display of feature coherence for a subset of the hierarchy. See also FIG. 6, elements 400′, 401′, 402′. Although not shown, such tables could obviously be adjoined horizontally to view a larger subset of the hierarchy, or if printed on a large poster, could be laid out in hierarchical fashion, or the like.

A tree-like view of the hierarchy is displayed in the left panel 401. In this exemplary embodiment, the tree having a topical “CLASS ROOT” (see FIG. 2) has parent class nodes 404 illustrated as designations: “52 42 Databases:0/350”, “0 0 Concurrency 50/50,” “27 16 Encryption and Compression: . . . ”, et seq. (see FIG. 2, nodes “A,” “A1” “B” . . . “N”). Indentation reflects the hierarchical structure. The display 400 left panel 401 includes a sorted list of the most coherent classes in the hierarchy (such as by the exemplary measure of coherence that underlies this visualization methodology and tool). FIG. 4D shows an exemplary sorted list provided at the bottom of 401, accessed by scrolling down; in other words, it has been found that it is best to also provide a listing 406 that provides topic nodes sorted by coherence, e.g., showing “Programming” from the left panel 401 in position 7 with a coherence factor of “27.” The two optional numbers before each class name are metrics related to the classes, e.g., the related coherence metric (further description is not relevant to the invention described herein). The two numbers following the each class name (i.e., each node and descendant node) are how many cases are in the class (before the slash mark) and how many total cases exist.

All class nodes 404 that have descendent nodes 405 in the hierarchy are interactive links on the display panel 401; that is, clicking or otherwise selecting one of them results in the display of a detailed view of information about the class and its descendants in the right panel 402 of the screen; e.g., shaded node designator 404 “58 43 Information Retrieval: 0/200” has been selected in 401. The descendent nodes 405 are labeled for this parent class node 404 are:

“0 0 Digital_Library:50/50”

“0 0 Extraction:50/50”

“0 0 Filtering:50/50” and

“0 0 Retrieval:50/50”.

Since much of this display is based on the distribution of features among the descendants 405 of a parent 404 node, this display 402 applies only to nodes with children, not to terminus (leaf) nodes (e.g., FIG. 2, A21) in a given hierarchy. The core of this display right panel 402 is a table 403 that contains an ordered list of features that are predictive of this class.

Above the table 403 of the right panel 402, a listing of the calculation factors and results used in the process steps 303-307 of FIG. 3 can provided as illustrated or as fits any particular implementation.

In general, looking at the overall structural features of the table 600 as shown in FIG. 6, one can immediately notice a visual distinction between the column labeled “Compress 50/50” and the two adjacent columns labeled “Encrypt 50/50” and “Securit 49/49.” Note that the rows for case features labeled “1. security 41−39−2” and “2. secure 33−36−4” and “3. authentication 24 32−238 have relatively thick bar-type indicators for those latter two adjacent columns whereas the “Compress 50/50” column includes totally different relatively thick bar-type indicators. Thus, there is an immediate visually perceptible indication from the single panel display that there is some incoherence, or non-uniformity, in the hierarchy structure for the “Node: Top/Encryption_and_Compression” worthy of further investigation. The other features of this display allow further study into the perceived deficiency.

Further Detailed Description of the Hierarchical Coherence Display Visualization Tool and Process for Generating Same

Annotated FIGS. 4B-4C is a detail of the table 403 of the right panel 402 of the display 400, showing detailed information about this visual representation of coherence of a selected individual class node (e.g., from FIG. 2, node A or node B . . . N or node A11 et seq., i.e., A\hat{ }; or, from FIG. 4A, the exemplary specific class node “Information_Retrieval” of the hierarchy tree).

In this exemplary embodiment, the table 403 has a column 411 (see also label “Predictive Features (sorted)” 411) that is displaying document word features 412, where the word features used were “text”, “documents”, “retrieval,” et seq., as shown going down along the column. These are the case features for the node, class A\hat{ }, currently under scrutiny. The numerals below the caption “node” are the number of cases stored at A*/number of total cases in A\hat{ }; in this example, “0/200” means there are no cases at A* but 200 cases total somewhere in A\hat{ }; see legend label 411′.

Each feature 412 has a corresponding row in the table 403. The core “Subtopic Columns” 413 are table 403 columns which correspond to the direct descendent nodes (e.g., subclasses of node A, B . . . N of FIG. 2, viz. e.g., A1, A2). In this implementation example, those descendent nodes are: “Digital_Library”, “Extraction”, “Filtering”, and “Retrieval” (see also FIG. 4, 405).

Each column of subclass region 413 has a header 415 that displays:

(1) (line 1) the name of the subclass,

(2) (line 1 after the slash mark “/”) the number of sub-classes plus 1, i.e., total descendants, including self,

(3) (line 2) the number of cases in the subclass but not its children, N(An*), and

(4) (line 2 after the “/”) the total number of cases in the subclass, N(An\hat{ }); see label 417.

For example, looking to the column labeled “Digital 50/50”, the meaning is there are fifty cases in this direct descendant node, “Digital*” and there are fifty in Digital\hat{ } (in this case, Digital is a leaf node, so they must be equal). The width of each of the subtopic columns 413 is displayed as proportional to N(An\hat{ }); in this case, an even subclass distribution (cf, briefly, FIG. 5, partial exemplary table 500 from a computer screen similar to FIG. 4A, where a single subclass “Machine” 501 dominates the distribution). Again, note that at a glance, due to the displayed colors (black and hatched in black and white drawing) that a pattern or set of patterns is quickly apparent to the eye which allows the user to visualize the inner nature of the hierarchy as it currently exists; for some users, slightly blurring their vision when looking at the screen may actually make features pop-out at them.

In each interior cell 419 of these Subtopic columns 413 of the table 403—corresponding to a feature “f” and a subclass Aj,—a “visualization gauge,” e.g. a distinctive bar 421, is provided (which is shaded in the drawings herein but preferably uses contrasting colors to highlight predictive features for subclasses).

The gauge 421 height reflects:

P(f |Aj\hat{ }), the average prevalence of feature f for Aj\hat{ } as determined by the derived distribution,

and the width reflects:

N(Aj).

Hence, each gauge area is proportional to N(f, Aj\hat{ }),

Area_{b}∝N(f, Aj\hat{ })=P(f/Aj\hat{ })·N(Aj\hat{ }) (Equation 2).

Optionally, the overall width of the table may reflect the value of N(A\hat{ }), relative to other tables. This option could be especially useful where the tables are in a printed format for side-by-side comparison.

In addition, referring to each interior cell 419 and label 423 therefor, the raw value of N(fi, Aj\hat{ }) in each cell is shown, followed by the log 10 of the significance test for the predictiveness of the feature (e.g., if Fisher's Exact Test yields a significance of 1×10-4, show a −4; i.e., larger negative numbers implies more predictive).

The color 421′ of the bar reflects whether the feature, decided by the threshold X, or “k,” supra, (e.g., FIG. 3, 306) does (e.g., bright orange (which is represented as hatched)) or does not (e.g., black) powerfully distinguish the subclass from its siblings.

For example, in FIGS. 4B-4C, the feature cell 412, “text”, in the first row, is strongly represented by relatively high gauge bars 421 in subclasses “Extraction” and “Filtering,” to a lesser extent in subclass “Retrieval,” the feature is significant (above threshold X) only for subclass “Filtering”. As another example, looking to the feature “information” (the fourth down in “Predictive feature (sorted)” 411 column) gauge bars, this feature is strongly represented in all four subclasses. Here, therefore, a contiguous set of significant bars is seen running across the table 403. Such prominent contiguous features are easily picked up visually by the user.

The rightmost column 431 (labeled and best seen in FIG. 4C) reflects the evenness of feature distribution, or uniformity measure, as calculated in step 307, FIG. 3, e.g., using the cosine function discussed above as an embodiment of this measure 431′, including a vector projection of the row features 412 distribution onto a class distribution vector 431″. In the visualization display table 403, if the Predictive feature 411 of this row is distributed substantially evenly among subclasses, this cell of column 413 is highlighted in the table in another color (e.g., bright green); see label 425. In this exemplary implementation, the highlighting occurs where the threshold for this is a cosine value of greater than 0.9 (Equation 1, supra). In the example, this is true for Predictive features 411 in the rows for: “4. information” and “8. web”. In rows where the state is false or normal, the raw data is displayed with a common background, e.g., white. Again, this provides another indicator which easily is picked up visually by the user. The listing above table 403 provides a summary of sufficiently evenly distributed among the children of A; i.e., with cosine of >0.9; and most prevalent. Then, these features are ordered by prevalence in A\hat{ }. Intuitively, the more of these features that exist and are highly prevalent, the more coherent class A.

Looking now to the left region—columns 441 and 411—of the table 403 (left of the “Subtopic columns 413”), the display 400 shows a split parent column 441, including another gauge bar 443. These left-hand two columns 441, 411 are representative of the current subtree selected, the parent and current node (versus the right-hand columns 413, 431 which discriminate among its descendant nodes). Illustrating below with the example of FIG. 4B, the top header cell indicates:

(1) (line 1) that this column represents the parent,

(2) (line 1 after the “/”) that there are 100 classes in parent\hat{ }, including parent* itself,

(3) (line 2) that there are 0 cases assigned to parent*, and

(4) (line 2 after the “/”) that there are 3474 cases assigned to the parent\hat{ }.

The remainder of column 441 is split in two; the width of the right-hand sub-column proportional to the number of documents in A\hat{ } versus its parent \hat{ }, N(A6)/N(parent\hat{ }),=200/3474. Each data cell in the remainder of the column 441 displays the following, illustrating with the data from the first row of FIG. 4B corresponding to the most predictive feature, e.g., “text”:

(1) (right hand sub-column) a bar gauge with height proportional to the average prevalence of the feature “text” in A\hat{ }, P(“text”/A\hat{ })=91/200,

(2) (left hand sub-column) a bar gauge with height proportional to the average prevalence of feature “text in A's parent * and sibling\hat{ }, P(“text”/documents in A's parent* and all sibling subtrees)=48/(3474-200), and

(3) (left hand sub-column, line 2) the number of times the feature “text” occurs in A's parent* and A's siblings' subtrees\hat{ }, N(“text”, A's parent* and siblings\hat{ })=48.

Note that the cell 412 to the right shows the number of times the feature “text” occurs in A\hat{ }, N(“text”, A\hat{ })=91. On line 2 of each cell 445, the absolute number of occurrences of the related feature is shown for the sibling classes and parent, e.g., “48” for “text,” “22” for “documents,” “28” for “retrieval,” et seq.

Looking again at each of the “Predictive features (sorted)” 411 column, each cell 412 thereunder has the number of occurrences N(f,A\hat{ }) and the two numbers immediately to the right show:

(1) the log10 of the Fisher's Exact Test for the feature with respect to A\hat{ } vs. its sibling topics, indicating the discriminating power of the feature sorted by the metric employed, and

(2) the maximum across all subtopics of the log10 of the Fisher's Exact Test for the feature with respect to the subtopic Ai\hat{ } vs. its sibling topics. In the table 403 of this example, the features are ordered by their predictive value towards the class A\hat{ }, e.g. the ninth column cell is “9. filtering” over “21−20−1.” Note that alternative orderings (or auxiliary views of the list of features) may be used; for example, ordered by their prevalence in A, or by their evenness of distribution among subclasses; see e.g., FIG. 4D. In one exemplary implementation, for example, the listed features are those which are:of sufficient predictive power towards A\hat{ }.

An additional example and use of the visualization method is shown in FIG. 6. This is another exemplary embodiment taken from the same data set as the example in FIG. 4A. This example differs from the previous in various respects. Most notably in this display table 600, none of the features 412 are uniformly distributed; therefore, there is no highlighting in column 431. This visualization tool aids the user immediately in several ways:

(1) none of the feature rows look like a relatively solid, uniform, fat bar going across the table 600 (compare e.g., FIG. 4A, row “4. information”);

(2) none of the feature rows at column 431 are highlighted in bright green (for there is no uniform distribution above the 0.9 threshold); and

(3) some of the rows have at least one bright orange cell, meaning the feature is predictive for one particular subclass, supra.

Moreover, that the collection of three subtopics intuitively breaks into two groups: features that either:

(1) support the leftmost subclass, “Compression”, or

(2) support the two right subclasses, “Encryption” and “Security.”

Therefore, this visualization tool table 600 suggests that perhaps the node “Encryption and Compression”, as defined in this example, is a rather unnatural grab bag of topics, and is a candidate for reorganization.

Other Alternative Embodiments

Referring back to FIG. 3, it will be apparent to those skilled in the art that there are a number of implementation choices which can be made. Referring to compiling features, step 301, there are a wide variety of “feature” engineering and selection strategies that will be related to the specific implementation. For example, feature engineering variants might look for two or three word phrases, noun-only terms, or the like. Other exemplary features are data file extension type, document length or any other substantive element which can be quantified. Feature selection techniques are similarly implementation dependent, e.g., selecting only those features with the highest information-gain or mutual-information metrics.

Referring to determining feature distinguishing power, step 305, other strategies besides Fisher's Exact Test for selecting the most predictive words include metric tools such as lift, odds-ratio, information-gain, Chi-Squared, and the like. Moreover, instead of selecting the “most predictive” features via selecting all those above some predetermined threshold, selection can be base on absolute limits, e.g., “top-50,” or on a dynamically selected threshold related to the particular implementation.

Referring to the computation of distribution of features, step 307 other strategies for finding “uniformly common” distributions may include selecting those average feature vectors with the greatest projection along the distribution vector among the descendants, selecting features that most likely fit the null hypothesis of the Chi-Squared test, or simply taking the average value of the top “k” features (where k=1,2,3, et seq.), or other weighting schedules, such as “1/i.” Alternatively, there are variants which may replace the notion of “uniformly common” altogether; e.g., using the maximum weighted projection of any feature selected, using the maximum average value of any feature selected, or the like.

The embodiments of the present invention provides a visual depiction of a combination of effects that are influential in classification (feature power, feature frequency, significance) that allows one to quickly identify nodes that cause problems for classification methods. The invention provides a way to identify classes that have much in common and belong together. The embodiments of the present invention allows the assessment of class coherence in situations where some features are strongly shared among items in the class, whereas others are not (causing clustering distance metrics to fail).

The foregoing description of the preferred embodiment of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . .”

What is claimed is:

1. A tool for analysis of a classification hierarchy, the tool comprising:
a panel; and
on said panel, a unified display having an intuitive visual representation of selected predictive features and distribution of said features within the classification hierarchy.

2. The tool as set forth in claim 1 wherein said features are representative of a set of cases and classification assignments of said cases within the classification hierarchy.

3. The tool as set forth in claim 1, the unified display further comprising:
said intuitive visual representation is a symbolic representation visually displaying coherence of said classification hierarchy.

4. The tool as set forth in claim 1, the unified display further comprising:
symbols representative of which said features are the most powerful in identifying a particular class with respect to structure of said classification hierarchy.

5. The tool as set forth in claim 1, wherein said classification hierarchy is characterized by parent nodes and descendant nodes, including sibling nodes, the unified display further comprising:
symbols representative of how said features are distributed over cases in said sibling nodes.

6. The tool as set forth in claim 1, the unified display further comprising:
symbols representative of which of the features relatively strongly distinguish among and help classify items of a class into subclasses of said classification hierarchy.

7. The tool as set forth in claim 5 further comprising:
a hierarchy tree showing all nodes of the classification hierarchy wherein said tree provides navigation access to the classification hierarchy structure.

8. The tool as set forth in claim 3 further comprising:
in proximity to each said symbolic representation, raw data explanatory of said symbolic representation.

9. The tool as set forth in claim 1 further comprising:
said intuitive visual representation is in a table, having columns associated with a selected classification hierarchy node and descendant nodes of said selected classification hierarchy node, rows associated with predictive features of said selected node, and symbols associated with table cells such that said intuitive representation is a symbolic representation visually displaying feature distribution across said descendant nodes.

10. A computerized tool for visualizing an organizational hierarchy, the tool comprising:
a paneled display of said hierarchy;
said display including data symbols representative of hierarchy classes, data symbols representative of hierarchy cases, and data symbols representative of features of said hierarchy cases; and
the data symbols representative of said classes, cases and features respectively show comparative metric relationships of said classes, cases and features such that relation thereof is visually displayed.

11. The tool as set forth in claim 10 comprising:
a first panel displaying hierarchy class nodes wherein each of said class nodes is representative of a class of the hierarchy such that said first panel is used for navigating said hierarchy.

12. The tool as set forth in claim 11 further comprising:
a computerized hierarchy navigation aid for selecting class nodes such that selecting a class node in said first panel opens a second panel for features of the same said class node.

13. The tool as set forth in claim 10 wherein said comparative metric relationships are displayed as visually perceptible gauges in proximity to each other such that said relation is provided as a contiguous bar chart for each of said features.

14. The tool as set forth in claim 10 wherein said comparative metric relationships are measures of prevalence of said features.

15. The tool as set forth in claim 10 wherein said comparative metric relationships are measures of population of said features.

16. The tool as set forth in claim 10 wherein said comparative metric relationships are measures of uniformity of distribution of features in said cases among said classes.

17. The tool as set forth in claim 10 wherein said comparative metric relationships are measures of predictiveness of said features for categorizing said cases for said classes in said hierarchy.

18. The tool as set forth in claim 10 in a hierarchy having parent, child, and sibling nodes, wherein said comparative metric relationships are measures of distribution of said features over sibling node classes.

19. The tool as set forth in claim 10 wherein said relation is representative of coherence within said hierarchy.

20. The tool as set forth in claim 10 in an integrated computer display.

21. The tool as set forth in claim 10 further comprising:
a display identifying classes for which additional training cases are likely to improve predictiveness for categorizing said cases in said classes in said hierarchy.

22. A method for displaying an organizational hierarchy structure, including a set of features of interest of individual cases of a class of the structure, the method comprising:
determining prevalence of each of said features of interest;
determining the distribution of each of said features of interest with respect to predetermined class groupings; and
displaying the relationship of said features of interest symbolically such that prevalence and distribution is in a visually distinctive form representative of the organizational hierarchy structure for said class.

23. The method as set forth in claim 22 wherein said displaying comprises:
hierarchical coherence for at least one class node of the hierarchy structure having descendant nodes is displayed.

24. The method as set forth in claim 23 comprising:
selecting a subset of features of said descendant nodes for said displaying.

25. The method as set forth in claim 22 comprising:
ordering said features according to said predictive power.

26. The method as set forth in claim 22 comprising:
determining a degree to which each of said features of interest is distributed substantially uniformly across the descendant nodes.

27. The method as set forth in claim 22 wherein said displaying comprises:
graphically representing a population distribution of said features-of-interest for a set of descendant nodes.

28. The method as set forth in claim 22 wherein said displaying comprises:
graphically representing said prevalence of said features-of-interest for a set of descendant nodes.

29. A method of doing business of analyzing a classification hierarchy structure, the method comprising:
receiving data representative of classes, cases, and case features of the structure;
analyzing feature distribution of said structure; and
providing a display having a unitary visual percept of said cases, classes and feature distribution.

30. A computer memory comprising:
computer code for determining prevalence of each of said features of interest;
computer code for determining the distribution of each of said features of interest with respect to predetermined class groupings; and
computer code displaying the relationship of said features of interest symbolically whereby prevalence and distribution is in a visually distinctive form representative of the organizational hierarchy structure for said class.

31. A method for analyzing feature relationships in a predetermined structure having hierarchy of classes, the method comprising:
creating a display having feature effects and distribution within the hierarchy; and
from said display, determining the intuitive predictiveness of the structure.

32. The method as set forth in claim 31, the method further comprising:
identifying classes for which additional training cases are likely to improve predictiveness.
